(19) United States
(12) Patent Application Publication
(10) Pub. No.: US 2013/0050283 A1
(43) Pub. Date: Feb. 28, 2013

(54) DISPLAY DEVICE AND ELECTRONIC UNIT

(71) Applicant: Yoshihisa Sato, Saitama (JP)

(72) Inventor: Yoshihisa Sato, Saitama (JP)

(73) Assignee: Sony Corporation, Tokyo (JP)

(21) Appl. No.: 13/560,712

(22) Filed: Jul. 27, 2012

(30) Foreign Application Priority Data
Aug. 30, 2011 (JP) 2011-187458

(51) Int. Cl. G09G 5/10

(52) U.S. Cl. 345/690

(57) ABSTRACT

A display device includes: a display section including a plurality of pixels each partitioned into a plurality of sub-pixel regions, and selectively performing two-dimensional image display based on a two-dimensional image signal or three-dimensional image display based on a three-dimensional image signal; and a separation section separating a plurality of perspective images provided for the three-dimensional image display when in a mode of three-dimensional image display. The display section separately drives each of the sub-pixel regions in each of the pixels according to a grayscale level when in a mode of two-dimensional image display. The display section drives the sub-pixel regions in each of the pixels, when in the mode of three-dimensional image display, to allow a drive state to be different from a drive state in the mode of two-dimensional image display.

### BACKGROUND

This disclosure relates to a display device capable of switching display between two-dimensional (2D) image display and three-dimensional stereoscopic (3D) image display, and to an electronic unit including such a display device.

For an image display device having a large screen, in order to obtain a wide viewing angle, a structure (multi-pixel structure) in which a unit pixel is divided into a plurality of sub-pixels having different thresholds has been proposed. The method used in the structure is called a HT (halftone-grayscale) method utilizing capacitive coupling, in which a potential difference between two sub-pixels is determined based on a capacitance ratio thereof.

Japanese Unexamined Patent Application Publication No. 2010-8681 proposes a liquid crystal display device having the multi-pixel structure using a halftone technique is proposed. This halftone technique increases luminance of a part of the pixel (one sub-pixel), and then increases luminance of the other part of the pixel (the other sub-pixel), during a process of increasing a grayscale level (increasing luminance) from a low level (a black display state) to a high level (a white display state). This enables to improve a viewing angle of the display device.

### SUMMARY

As a method to achieve naked-eye type stereoscopic display, a parallax barrier system is known. In the parallax barrier system, a parallax barrier having a plurality of slit-like openings is provided on the front or back side of a display panel such as a liquid crystal panel. Images displayed on the display panel are separated by the parallax barrier to allow different images to enter the right and left eyes of a viewer, and thereby stereoscopic display is performed.

In such a naked-eye type stereoscopic display device, when display drive is performed utilizing the halftone technique in a display panel, image quality may be deteriorated.

It is desirable to provide a display device and an electronic unit capable of improving image quality in both 2D display and 3D display.

According to an embodiment of the present disclosure, there is provided a display device including: a display section including a plurality of pixels each partitioned into a plurality of sub-pixel regions, and selectively performing two-dimensional image display based on a two-dimensional image signal or three-dimensional image display based on a three-dimensional image signal; and a separation section separating a plurality of perspective images provided for the three-dimensional image display when in a mode of three-dimensional image display. The display section separately drives each of the sub-pixel regions in each of the pixels according to a grayscale level when in a mode of two-dimensional image display. The display section drives the sub-pixel regions in each of the pixels, when in the mode of three-dimensional image display, to allow a drive state to be different from a drive state in the mode of two-dimensional image display.

According to an embodiment of the present disclosure, there is provided an electronic unit including a display, the display including: a display section including a plurality of pixels each partitioned into a plurality of sub-pixel regions, and selectively performing two-dimensional image display based on a two-dimensional image signal or three-dimensional image display based on a three-dimensional image signal; and a separation section separating a plurality of perspective images provided for the three-dimensional image display when in a mode of three-dimensional image display. The display section separately drives each of the sub-pixel regions in each of the pixels according to a grayscale level when in a mode of two-dimensional image display. The display section drives the sub-pixel regions in each of the pixels, when in the mode of three-dimensional image display, to allow a drive state to be different from a drive state in the mode of two-dimensional image display.

In the display device and the electronic unit according to the embodiments of the present disclosure, when the two-dimensional image display is performed, each of the plurality of sub-pixel regions in each of the pixels are separately driven according to the grayscale level. When in the mode of tree-dimensional image display, the plurality of sub-pixel regions in each of the pixels are driven to be in the drive state different from that in the mode of two-dimensional image display.

According to the display device and the electronic unit of the embodiments of the present disclosure, the plurality of sub-pixel regions are driven in different states between 2D display and 3D display. Therefore, image quality is improved in both the 2D display and the 3D display.

It is to be understood that both the foregoing general description and the following detailed description are exemplary, and are intended to provide further explanation of the technology as claimed.

### BRIEF DESCRIPTION OF THE DRAWINGS

The accompanying drawings are included to provide a further understanding of the disclosure, and are incorporated in and constitute a part of this specification. The drawings illustrate embodiments and, together with the specification, serve to explain the principles of the technology.

FIG. 1 is a block diagram illustrating a configuration example of a display device according to an embodiment of the present disclosure.

FIG. 2 is a block diagram illustrating an operation in performing 2D display.

FIG. 3 is a block diagram illustrating an operation in performing 3D display.

FIG. 4 is a plan view illustrating an example of a pixel structure of a display section.

FIG. 5 is a plan view illustrating an example in a case where only pixels in an A region are in a white display state in the display section.

FIG. 6 is a plan view illustrating an example in a case where the pixels in the A region and pixels in a B region are in the white display state in the display section.

FIGS. 7A and 7B are a plan view and a cross-sectional view illustrating a first example to see an image of 100 IRE (having luminance of 100%) through opening sections, respectively.

FIGS. 8A and 8B are a plan view and a cross-sectional view illustrating a second example to see the image of 100 IRE (having luminance of 100%) through the opening sections, respectively.

FIGS. 9A and 9B are a plan view and a cross-sectional view illustrating a first example to see an image of 40 IRE (having luminance of 40%) through the opening sections, respectively.

FIGS. 10A and 10B are a plan view and a cross-sectional view illustrating a second example to see the image of 40 IRE (having luminance of 40%) through the opening sections, respectively.

FIG. 11 is an explanatory diagram illustrating a simulation result on occurrence of moire.

FIG. 12 is an explanatory diagram illustrating a viewing condition of the simulation described in FIG. 11.

FIG. 13 is an explanatory diagram illustrating an example of a drive state of a pixel in 2D display.

FIG. 14 is an explanatory diagram illustrating an example of a drive state of a pixel in 3D display.

FIG. 15 is a diagram illustrating an appearance of an exemplary electronic unit.

### DETAILED DESCRIPTION

Hereinafter, preferred embodiments of the present disclosure will be described in detail with reference to the drawings.

### [General Configuration of Display Device]

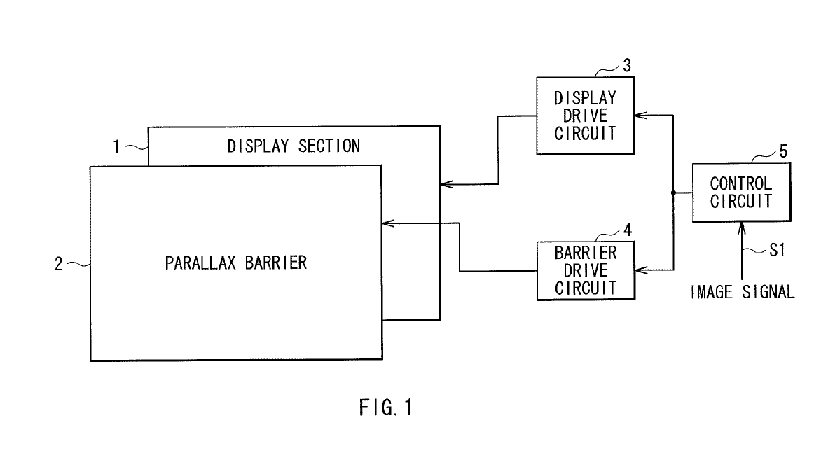

FIG. 1 illustrates a configuration example of a display device according to an embodiment of the present disclosure. The display device includes a display section 1, a parallax barrier 2, a display drive circuit 3, a barrier drive circuit 4, and a control circuit 5.

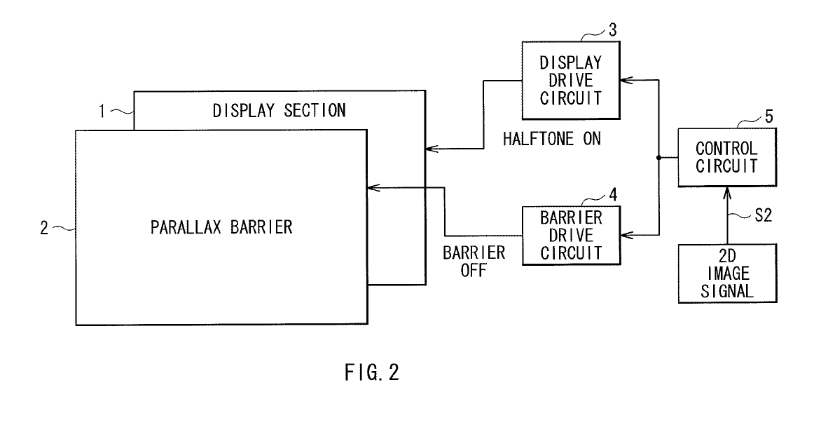

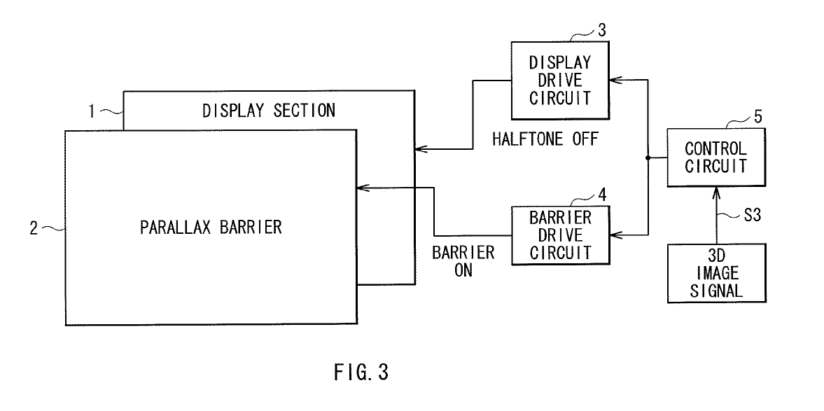

The display device freely and selectively switches a display mode thereof between a two-dimensional (2D) display mode in the entire screen and a three-dimensional (3D) display mode in the entire screen. Switching between the two-dimensional display mode and the three-dimensional display mode is allowed by controlling switching of an image displayed on the display section 1 and controlling ON and OFF of a parallax separation function (barrier function) of the parallax barrier 2. FIG. 2 illustrates an operation state in the two-dimensional display mode, and FIG. 3 illustrates an operation state in the three-dimensional display mode.

The control circuit 5 receives an image signal 51 from the outside of the device. The control circuit 5 controls a display operation of the display section 1 and a drive operation of the parallax barrier 2 according to whether the image signal 51 is a two-dimensional image signal S2 (FIG. 2) or a three-dimensional image signal S3 (FIG. 3). The three-dimensional image signal S3 is an image signal including parallax information. The display drive circuit 3 drives the display section 1 in accordance with the control by the control circuit 5. The barrier drive circuit 4 is controlled by the control circuit 5 to drive the parallax barrier 2.

The display section 1 displays an image on a two-dimensional plane, and includes, for example, a combination of a liquid crystal panel and a backlight. The parallax barrier 2 is arranged between the display section 1 and a viewer, and allows light emitted from the display section 1 to enter. It is to be noted that the parallax barrier 2 may be arranged between the liquid crystal panel and the backlight.

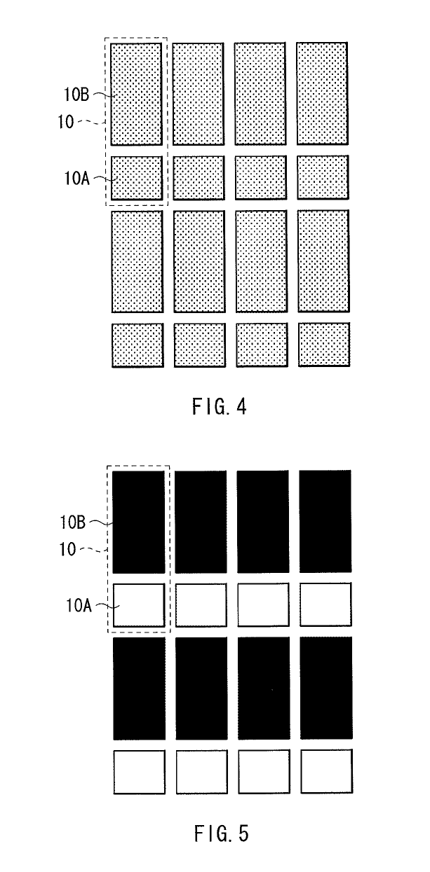

The display section 1 performs image display based on the two-dimensional image signal S2 or the three-dimensional image signal S3. The display section 1 includes a plurality of pixels 10 arranged on a two-dimensional plane as shown in FIG. 4. In the case where the image display is performed based on the three-dimensional image signal S3, a plurality of perspective images based on the three-dimensional image signal S3 are assigned to each pixel 10 to be displayed.

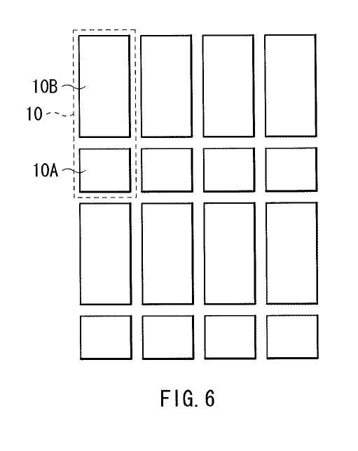

Each pixel in the display section 1 is partitioned into two separate sub-pixel regions (an A region and a B region) as shown in FIG. 4. A luminance of a sub-pixel 10A in the A region and a luminance of a sub-pixel 10B in the B region are controlled separately to perform a so-called halftone control, thereby achieving display with wide viewing angle in two-dimensional display. For example, when halftone display is performed, as shown in FIG. 5, it is possible to control only the sub-pixel 10A in the A region to have high luminance (white display) and control the sub-pixel 10B in the B region to have low luminance (black display). As shown in FIG. 6, it is also possible to control the sub-pixel 10A in the A region and the sub-pixel 10B in the B region to have high luminance (white display), and thereby to allow the entire pixel to perform white display. Moreover, it is also possible not to perform the halftone control. For example, the sub-pixel 10A in the A region and the sub-pixel 10B in the B region may all be controlled to have the same grayscale level while the display is changed from a low grayscale level to a high grayscale level.

The parallax barrier 2 includes, for example, a liquid crystal barrier in which light transmittance is allowed to be controlled with a liquid crystal material. The parallax barrier 2 has a function as a separation section separating the plurality of perspective images that are based on the three-dimensional image signal S3, when image display is performed based on the three-dimensional image signal S3 (three-dimensional display mode). Further, the parallax barrier 2 switches the function (barrier function) of separating the perspective images between ON and OFF. The barrier drive circuit 4 switches ON and OFF of the barrier function according to the control by the control circuit 5. When the barrier function is turned off, the entire surface of the parallax barrier 2 becomes transmissive.

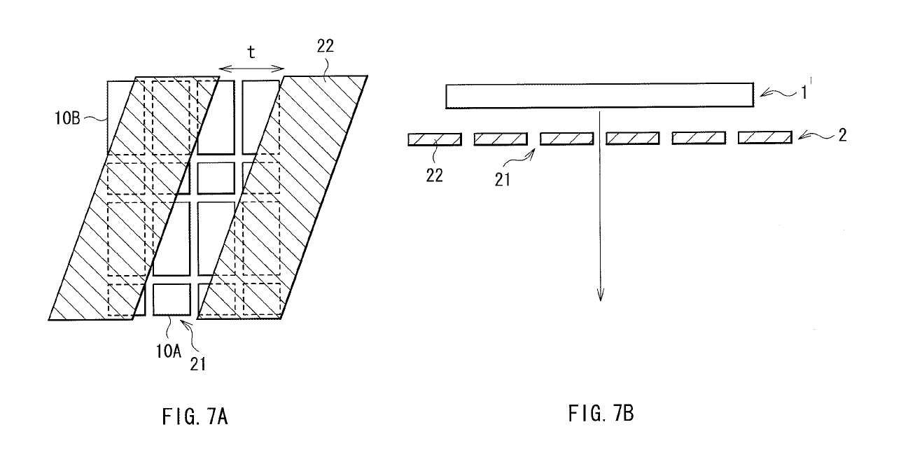

In a case where the barrier function of the parallax barrier 2 is ON, for example, as shown in FIGS. 7A and 7B, a plurality of slit-like opening sections 21 extending in a predetermined direction are formed. Shielding sections 22, which do not transmit light, are formed between the plurality of opening sections 21. The opening sections 21 limit an emission angle of each perspective image with respect to a viewer according to the position relation of the pixel 10 and the opening sections 21.

### [Description on Occurrence of Moire]

In the present embodiment, the display section 1 drives, in the two-dimensional display mode, separately the sub-pixel 10A in the A region and the sub-pixel 10B in the B region in each pixel 10 according to a grayscale level. In other words, the halftone control is operated in the ON state. In the three-dimensional display mode, the sub-pixel 10A in the A region and the sub-pixel 10B in the B region in each pixel 10 are driven in a drive state different from that in image display based on the two-dimensional image signal S2. In particular, the halftone control is turned off and the sub-pixel 10A in the A region and the sub-pixel 10B in the B region in each pixel 10 are concurrently driven irrespective of the grayscale level.

The halftone control in the display section 1 is turned off during the operation in the three-dimensional display mode to suppress moire which occurs in the case where the halftone control is ON in the three-dimensional display mode, as described below.

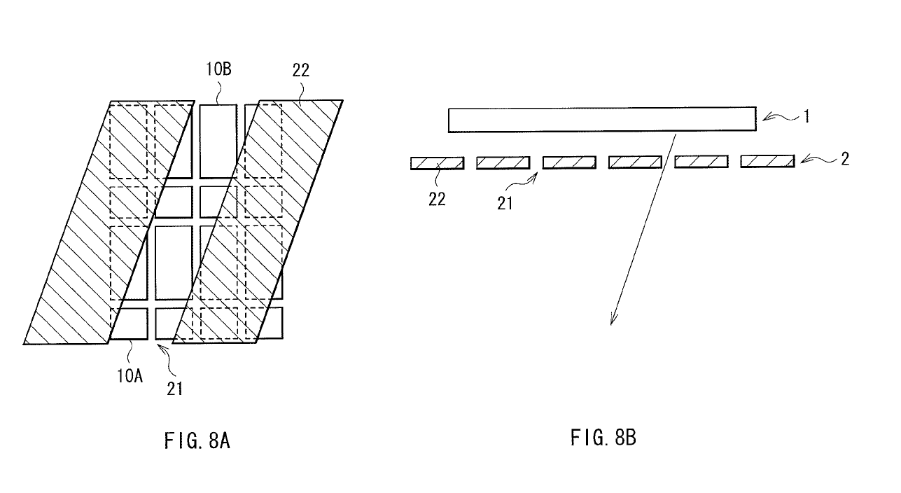

In the three-dimensional display mode, a viewer sees the pixel 10 in the display section 1 through the openings 21 of the parallax barrier 2. FIGS. 7A to 8B each illustrate how an image is viewed through the openings 21 in a case where an image of 100 IRE (having luminance of 100%) is displayed on the display section 1. FIGS. 7A and 7B illustrate a case where the middle of the screen is viewed from the front. FIGS. 8A and 8B illustrate a case where a position in the screen slightly shifted to right from the position shown in FIGS. 7A and 7B is viewed from an slightly-oblique direction. FIGS. 7A to 8B illustrate cases where an opening pitch “t” of the opening sections 21 is larger than a pitch of one pixel (one sub-pixel) in the display section 1. In the case where the image of 100 IRE (having luminance of 100%) is displayed, the luminance of light rays passing through the opening sections 21 does not differ much between the case shown in FIGS. 7A and 7B where the middle of the screen is viewed and the case shown in FIGS. 8A and 8B where the position slightly shifted to right from the middle of the screen is viewed.

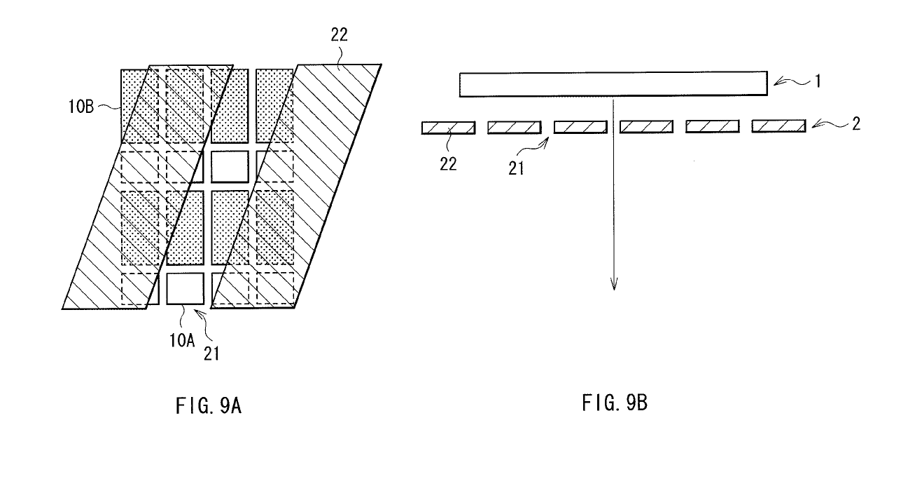

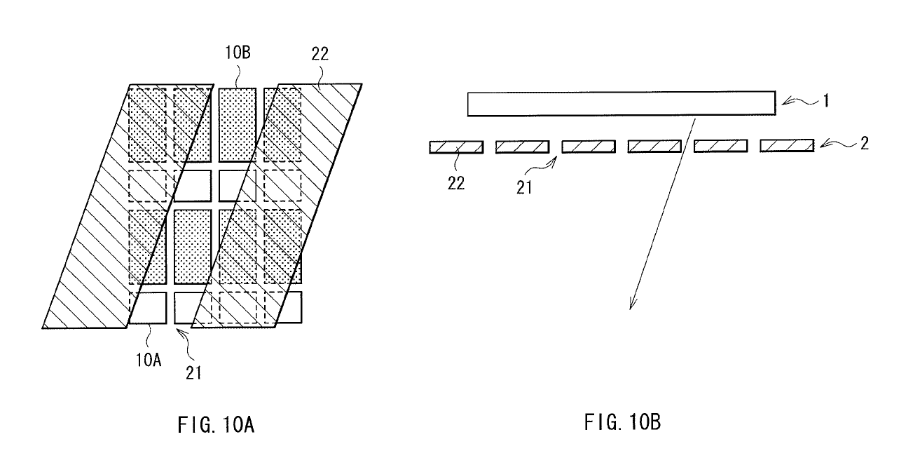

FIGS. 9A to 10B each illustrate how an image is viewed through the openings 21 in a case where an image of 40 IRE (having luminance of 40%) is displayed on the display section 1. In FIGS. 9A to 10B, the halftone control is turned on. FIGS. 9A and 9B illustrate, as with FIGS. 7A and 7B, the case where the middle of the screen is viewed from the front. FIGS. 10A and 10B illustrate, as with FIGS. 8A and 8B, the case where the position of the screen slightly shifted to right from the middle is viewed from the slightly-oblique direction. Compared with the case of the image of 100 IRE, the amount of change in the luminance of the light rays passing through the opening sections 21 is larger between the case shown in FIGS. 9A and 9B where the middle of the screen is viewed and the case shown in FIGS. 10A and 10B where the position slightly shifted to right from the middle of the screen is viewed. One reason is that a region in which light is emitted is made smaller by turning on the halftone control. The amount of light from the pixel 10 passing through the opening sections 21 is determined according to the position relation between the viewer and the opening sections 21. The variation of the light amount increases depending on the position of the screen to be viewed in the horizontal direction, which is, in turn, perceived as moire.

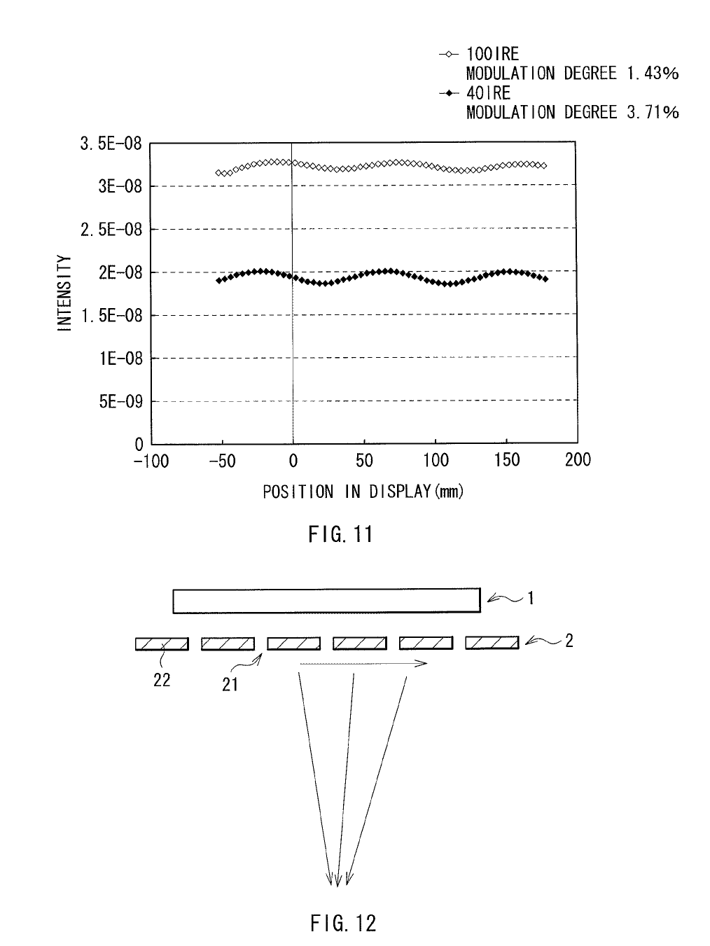

FIG. 11 illustrates a simulation of how the moire is observed in the images of 100 IRE and 40 IRE. FIG. 11 shows a result of luminance distribution in a case where the halftone control is ON and the viewing position is shifted in the horizontal direction as shown in FIG. 12. A horizontal axis indicates the horizontal position in the screen, and a vertical axis indicates the amount of light. The ratio (modulation degree) between a light part and a dark part is 1.43% in the image of 100 IRE and 3.71% in the image of 40 IRE. It can be seen from FIG. 11 that the moire is worsened due to the halftone derived from the halftone control.

### [Operation of Display Device]

In the display device, the two-dimensional image signal S2 (FIG. 2) or the three-dimensional image signal S3 (FIG. 3) is input to the control circuit 5 as the image signal S1. In the case where the two-dimensional image signal S2 (FIG. 2) is input, the control circuit 5 outputs the two-dimensional image signal S2 to the display drive circuit 3. The control circuit 5 also outputs, to the display drive circuit 3, a signal to allow the display drive circuit 3 to perform the halftone control. Further, the control circuit 5 turns off the barrier function of the parallax barrier 2 with the drive circuit 4, thereby allowing the entire barrier to be in the opened state (transmissive state). Thus, the two-dimensional image displayed on the display section 1 is presented to the viewer as it is.

When the control circuit 5 receives the three-dimensional image signal S3 (FIG. 3), the control circuit 5 outputs the three-dimensional image signal S3 to the display drive circuit 3. The control circuit 5 also instructs the display drive circuit 3 not to perform the halftone control. Further, the control circuit 5 turns on the barrier function of the parallax barrier 2 with the barrier drive circuit 4, thereby providing the opening sections 21 and the shielding sections 22 in the parallax barrier 2. The viewer sees an image through the opening sections 21 of the parallax barrier 2, thereby perceiving a stereoscopic image.

### [Specific Example of Driving Pixel 10]

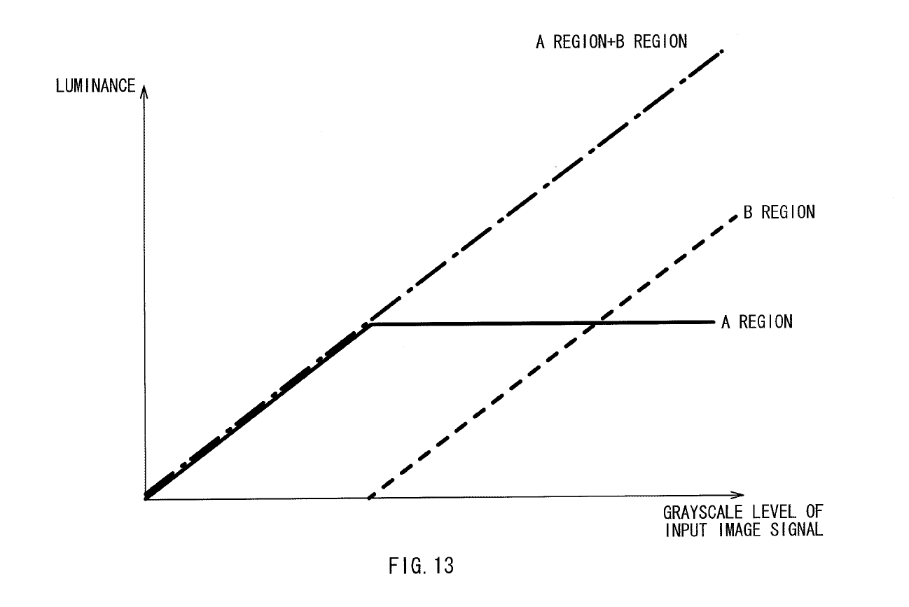

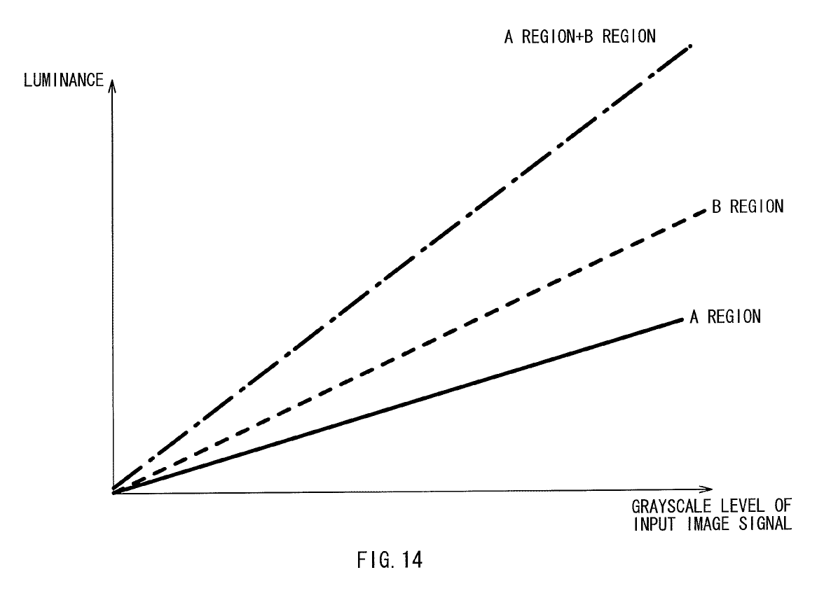

A specific example of driving the pixel 10 will be described with reference to FIGS. 13 and 14. The display drive circuit 3 is controlled by the control circuit 5 to allow an image to be displayed in two states, which are a state where the halftone control is performed and a state where the halftone control is not performed. In performing the halftone control (FIG. 13), one pixel in the display section 1 is divided into the sub-pixels 10A and 10B of two region (the A region and the B region) to drive the pixel 10. When the grayscale level is changed from 0IRE (luminance of 0%) to 100 IRE (luminance of 100%), first, the luminance of either of the regions (the A region in FIG. 13) is increased from 0 to the maximum level. Thereafter, the sub-pixel 10B is driven so that the luminance thereof is increased from 0 to the maximum level while the grayscale level of the sub-pixel 10A in the A region is kept at the maximum. Such halftone control allows the viewing angle in the horizontal direction to be increased in the two-dimensional display mode.

On the other hand, in the case where the halftone control is not performed (FIG. 14), when the grayscale level is changed from 0 IRE (luminance of 0%) to 100 IRE (luminance of 100%), the luminance of the sub-pixel 10A in the A region and the luminance of the sub-pixel 10B in the B region are increased in the same way. Therefore, light is emitted from the entire surface of the pixel 10 even when the image is displayed with low grayscale level. Accordingly, the moire observed in three-dimensional display is decreased. It is to be noted that, since the area of the B region is larger than that of the A region, the luminance of the A region as a whole is lower than that of the B region as a whole in FIGS. 13 and 14.

### [Effect]

As described above, in the display device according to the present embodiment, the plurality of sub-pixel regions are driven in different drive states depending on whether the display device performs 2D display or 3D display. Therefore, the image quality in both the 2D display and the 3D display is improved. In particular, in the two-dimensional display mode, the halftone function is used to improve the viewing angle. In the three-dimensional display mode, the halftone function is turned off to improve the moire.

### [Other Embodiments]

The technology of the present disclosure is not limited to the embodiment described above, and various modifications may be made.

For example, as the separation section used for switching between the two-dimensional display mode and the three-dimensional display mode, a variable lenticular lens may be used instead of the parallax barrier 2. Examples of the variable lenticular lens include a liquid crystal lens and a liquid lens.

Also, although the embodiment is described above with the example where the pixel 10 is partitioned into two sub-pixel regions, the pixel may be partitioned into three or more regions.

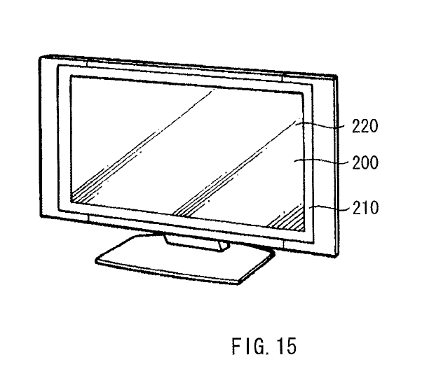

Further, the display device according to the above-described embodiments is applicable to various electronic units having a display function. FIG. 15 illustrates an appearance and a configuration of a television device as an example of such an electronic unit. The television device includes an image display screen section 200 having a front panel 210 and a filter glass 220. The display device according to the embodiment is also applicable to electronic units such as various digital cameras, camcorders, mobile phones, and laptop personal computers, in addition to the television device.

Thus, it is possible to achieve at least the following configurations from the above-described example embodiments and the modifications of the disclosure.

(1) A display device including:

a display section including a plurality of pixels each partitioned into a plurality of sub-pixel regions, and selectively performing two-dimensional image display based on a two-dimensional image signal or three-dimensional image display based on a three-dimensional image signal; and

a separation section separating a plurality of perspective images provided for the three-dimensional image display when in a mode of three-dimensional image display, wherein

the display section separately drives each of the sub-pixel regions in each of the pixels according to a grayscale level when in a mode of two-dimensional image display, and

the display section drives the sub-pixel regions in each of the pixels, when in the mode of three-dimensional image display, to allow a drive state to be different from a drive state in the mode of two-dimensional image display.

(2) The display device according to (1), wherein the display section concurrently drives the sub-pixel regions in each of the pixels irrespective of the grayscale level when in the mode of three-dimensional image display.

(3) The display device according to (1) or (2), wherein the separation section is a parallax barrier that turns on and off a function of separating the perspective images.

(4) An electronic unit including a display, the display including:

a display section including a plurality of pixels each partitioned into a plurality of sub-pixel regions, and selectively performing two-dimensional image display based on a two-dimensional image signal or three-dimensional image display based on a three-dimensional image signal; and

a separation section separating a plurality of perspective images provided for the three-dimensional image display when in a mode of three-dimensional image display, wherein

the display section separately drives each of the sub-pixel regions in each of the pixels according to a grayscale level when in a mode of two-dimensional image display, and

the display section drives the sub-pixel regions in each of the pixels, when in the mode of three-dimensional image display, to allow a drive state to be different from a drive state in the mode of two-dimensional image display.

The present application contains subject matter related to that disclosed in Japanese Priority Patent Application JP 2011-187458 filed in the Japan Patent Office on Aug. 30, 2011, the entire content of which is hereby incorporated by reference.

It should be understood by those skilled in the art that various modifications, combinations, sub-combinations, and alterations may occur depending on design requirements and other factors insofar as they are within the scope of the appended claims or the equivalents thereof.

What is claimed is:

1. A display device comprising:
a display section including a plurality of pixels each partitioned into a plurality of sub-pixel regions, and selectively performing two-dimensional image display based on a two-dimensional image signal or three-dimensional image display based on a three-dimensional image signal; and
a separation section separating a plurality of perspective images provided for the three-dimensional image display when in a mode of three-dimensional image display, wherein
the display section separately drives each of the sub-pixel regions in each of the pixels according to a grayscale level when in a mode of two-dimensional image display, and
the display section drives the sub-pixel regions in each of the pixels, when in the mode of three-dimensional image display, to allow a drive state to be different from a drive state in the mode of two-dimensional image display.

2. The display device according to claim 1, wherein the display section concurrently drives the sub-pixel regions in each of the pixels irrespective of the grayscale level when in the mode of three-dimensional image display.

3. The display device according to claim 1, wherein the separation section is a parallax barrier that turns on and off a function of separating the perspective images.

4. An electronic unit including a display device, the display device comprising:
a display section including a plurality of pixels each partitioned into a plurality of sub-pixel regions, and selectively performing two-dimensional image display based on a two-dimensional image signal or three-dimensional image display based on a three-dimensional image signal; and
a separation section separating a plurality of perspective images provided for the three-dimensional image display when in a mode of three-dimensional image display, wherein
the display section separately drives each of the sub-pixel regions in each of the pixels according to a grayscale level when in a mode of two-dimensional image display, and
the display section drives the sub-pixel regions in each of the pixels, when in the mode of three-dimensional image display, to allow a drive state to be different from a drive state in the mode of two-dimensional image display.
